(19) United States
(12) Patent Application Publication
(10) Pub. No.: US 2016/0369891 A1
(43) Pub. Date: Dec. 22, 2016

(54) METHOD FOR CONTROLLING AUTOMATED MANUAL TRANSMISSION

(71) Applicant: HYUNDAI MOTOR COMPANY, Seoul (KR)

(72) Inventors: Soon Ki Eo, Ansan-si (KR); Chae Hong Lim, Seoul (KR); Young Min Yoon, Suwon-si (KR); Chon Ok Kim, Yongin-si (KR)

(73) Assignee: HYUNDAI MOTOR COMPANY, Seoul (KR)

(21) Appl. No.: 14/885,170

(22) Filed: Oct. 16, 2015

(30) Foreign Application Priority Data
Jun. 16, 2015 (KR) 10-2015-0085419

(51) Int. Cl. F16H 61/20

(52) U.S. Cl. CPC F16H 61/20; F16H 2061/202

(57) ABSTRACT

A method for controlling an automated manual transmission includes a plurality of clutches in a vehicle. The method includes deciding whether the vehicle is in a creep driving condition and sensing an opening rate of a brake pedal when the vehicle is in the creep driving condition. The method further includes controlling slipping of the plurality of clutches depending on the opening rate of the brake pedal to generate a creep torque.

### CROSS-REFERENCE TO RELATED APPLICATIONS

This application claims the benefit of Korean Patent Application No. 10-2015-0085419 filed Jun. 16, 2015, the entire contents of which are incorporated by reference herein in their entirety.

### FIELD

The present disclosure relates to a method for controlling creep driving in a vehicle mounted with an automated manual transmission including a plurality of clutches.

### BACKGROUND

The statements in this section merely provide background information related to the present disclosure and may not constitute prior art.

Generally, a vehicle mounted with an automated transmission is designed to control an oil pressure within speed change ranges set according to vehicle speeds to automatically operate a change gear in a target gear step. Particularly, when a change lever of an automated transmission-mounted vehicle is in a D range, the vehicle can be driven in a creep driving mode by the idle power of the engine.

However, a vehicle mounted with a DCT (dual clutch transmission), a kind of automated manual transmission, needs an additional clutch slip control for creep driving. That is, when the clutch in odd-number gear steps is engaged into a first gear step, creep driving starts by slightly slipping or disengaging. With reference to FIGS. 1 and 2, there are graphs in which a drive shaft torque and a vehicle speed are changed according to a conventional clutch slip control.

When clutches are quickly connected as shown in FIG. 1, the torque of the drive shaft becomes unstable because the torsion spring in the clutch disk vibrates. Accordingly, the vehicle changes in speed, and undergoes sudden shock. As a result, the creep driving may become unstable, and might cause the driver to feel uncomfortable.

The vibration of the torsion spring is conventionally removed by making the clutch connection slow, thereby solving the torque instability of a drive shaft. However, the response of the vehicle is delayed with a gradual increase in the torque of the drive shaft, thereby causing the driver to feel an uncomfortable driving sensation.

### SUMMARY

The present disclosure provides a method for controlling an automated manual transmission including a plurality of clutches in which when a vehicle mounted with the automated manual transmission starts creep driving, a creep torque is generated with the plurality of clutches to enhance the vehicle in creep driving stability and driving response.

Additionally, it is understood that the below methods are executed by at least one control unit or controller. The term control unit or controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

The present disclosure provides a method for controlling an automated manual transmission including a plurality of clutches in a vehicle comprising: deciding whether the vehicle is in a creep driving condition; sensing an opening rate of a brake pedal when the vehicle is in the creep driving condition; and slipping the plurality of clutches depending on the opening rate of the brake pedal to generate a creep torque.

In the deciding step, the vehicle is determined to be in a creep driving condition in when the vehicle runs at a speed less than a reference value, with a change lever in a D range under an OFF state of both a brake pedal and an accelerator pedal.

In the generating step, a first clutch, one of the multiple clutches, is slipped at a first speed to a slip extent according to the opening rate of the brake pedal while a second clutch, the other clutch of the multiple clutches, is slipped at a second speed to a slip extent according to the opening rate of the brake pedal.

In one form, the first speed and the second speed are set to be less than a clutch slip speed at which a torsion spring vibrates.

As described above, the control method of an automated manual transmission with the above structure can increase the driving response of a vehicle mounted with the automated manual transmission during creep driving, and thus can enhance the marketability of the vehicle.

In addition, upon quick clutch connection, the creep driving of the vehicle can be stabilized by limiting the slip speeds of the clutches.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graph showing that a drive shaft torque and a vehicle speed are changed according to a conventional clutch slip control;

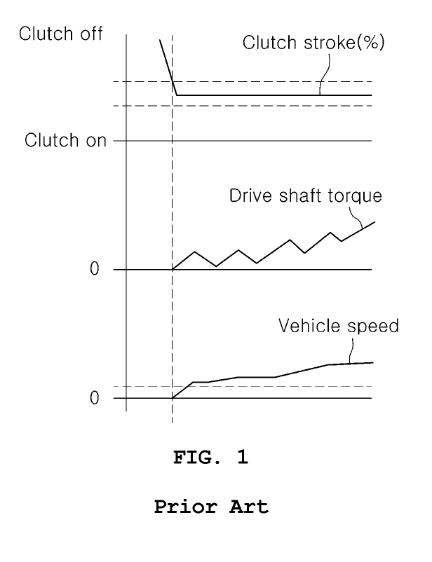

FIG. 2 is a graph showing that a drive shaft torque and a vehicle speed are changed according to a conventional clutch slip control;

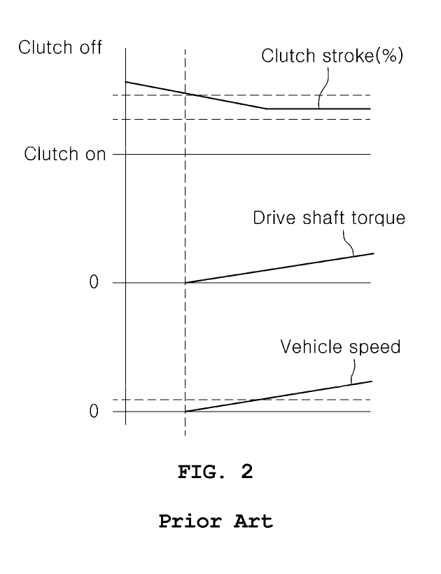

FIG. 3 is a flow chart illustrating a method for controlling an automated manual transmission in accordance with a form of the present disclosure; and

FIG. 4 is a graph showing changes in drive shaft torque and vehicle speed in accordance with a form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A method for controlling an automated manual transmission in accordance with one form of the present disclosure will be described with reference to the accompanying drawings.

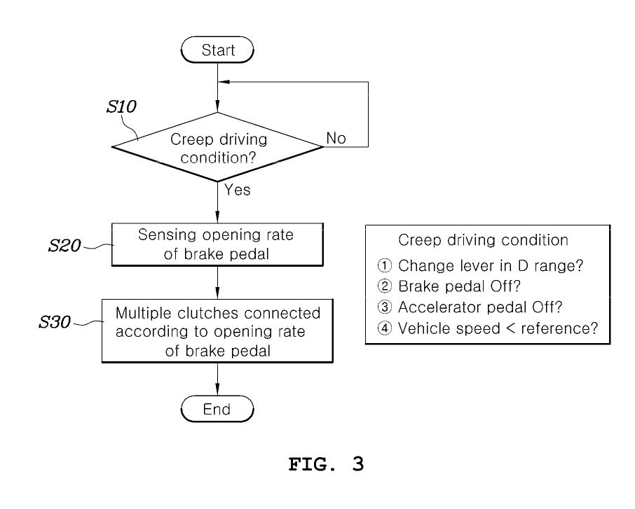

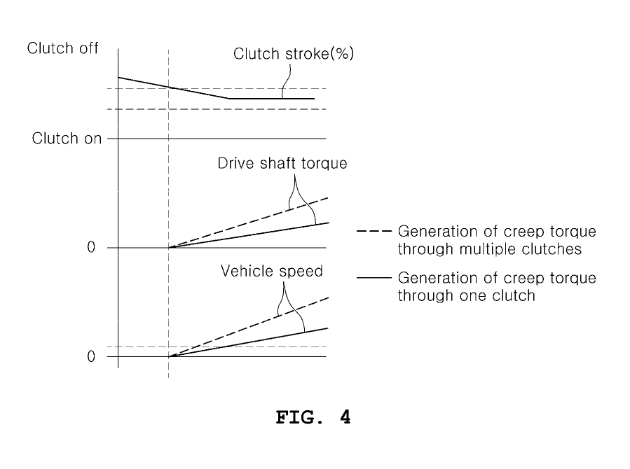

FIG. 3 is a flow chart illustrating a method for controlling an automated manual transmission in accordance with one form of the present disclosure. FIG. 4 is a graph showing changes in drive shaft torque and vehicle speed in accordance with one form of the present disclosure. With reference to FIGS. 3 and 4, the method for controlling an automated manual transmission including a plurality of clutches in a vehicle comprises deciding whether the vehicle is in a creep driving condition (S10); sensing an opening rate of a brake pedal when the vehicle is in the creep driving condition (S20); and slipping the plurality of clutches depending on the opening rate of the brake pedal to generate a creep torque (S30).

The automated manual transmission may be a dual clutch transmission (DCT) composed of a plurality of clutches, or a torque-assist automated manual transmission (AMT) in which an additional clutch disposed in a gear position is operated separately from a clutch in another gear position.

Conventional automated manual transmissions provided with a plurality of clutches do not perform creep driving, or perform creep driving by separately slip-controlling one of odd-number position clutches. However, when creep driving is performed with only one clutch, driving response decreases. To overcome this problem, all the multiple clutches are subjected to a slip control to generate a creep torque necessary for creep driving in accordance with the present disclosure. This method allows a vehicle to be rapidly driven in response to a driver's request for creep driving, thereby enhancing driving response upon creep driving.

In the decision step (S10), the vehicle is determined to be in a creep driving condition when the vehicle runs at a speed less than a reference value with a change lever in a D range under an OFF state of both a brake pedal and an accelerator pedal.

Generally, a driver's creep driving is performed when all the above conditions are met, that is, when a brake pedal is converted from an ON state to an OFF state at a vehicle speed less than a reference value with a change lever in a D range.

Accordingly, a control unit may sense an opening rate of the brake pedal (S20) to perform creep control when the creep driving condition is met. On the other hand, when even one of the creep driving conditions is not met, the control unit determines that the driver does not intend to perform creep control and continuously whether the vehicle is in a creep driving condition (S10).

After the vehicle senses the opening rate of the brake pedal as a creep driving condition, a plurality of clutches is under a slip control to generate a creep torque. In the generating step (S30), a first clutch, one of the multiple clutches, is slipped at a first speed to a slip extent according to the opening rate of the brake pedal while a second clutch, the other clutch, is slipped at a second speed to a slip extent according to the opening rate of the brake pedal.

For instance, when a vehicle starts to perform creep driving by releasing a brake pedal from a depressed position, multiple clutches are slipped to a slip extent preset according to the opening rate of the brake pedal to achieve a vehicle speed that the driver requires.

Here, the first speed and the second speed are set to be less than a clutch slip speed at which a torsion spring vibrates.

For example, when a clutch is slipped to a large extent within a short time, a torsion spring within a clutch disk vibrates to change a torque value of the drive shaft, thereby causing the vehicle speed to be unstable. To avoid this problem, a clutch slip speed is set to be less than a speed at which a torsion spring vibrates, so that the creep driving of the vehicle can be stabilized. In spite of this condition, a faster driving response can be achieved than when one clutch is used because a plurality of clutches are used to generate a creep torque.

In addition, the first speed and the second speed may be variably set to be the same or different according to designers or vehicles, and are not limited to particular values.

In one form shown in FIG. 4, the clutch stroke is represented by one line because the first clutch and the second clutch are identical in slip extent and slip speed to each other. When a clutch stroke reaches a half-clutch range, the multiple clutches increase the drive shaft torque, with the consequent increase of the vehicle speed. However, when creep torque is generated with multiple clutches, a driving response time, which a driver feels is shorter than when one clutch is used, is provided. Therefore, an improvement in the driver's driving response can contribute to an improvement of the marketability of the vehicle.

The control method of an automated manual transmission with the above structure can increase the driving response of a vehicle mounted with the automated manual transmission during creep driving, and thus can enhance the marketability of the vehicle.

In addition, upon quick clutch connection, the creep driving of the vehicle can be stabilized by limiting the slip speeds of the clutches.

Although the various forms of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method for controlling an automated manual transmission including a plurality of clutches in a vehicle comprising:
deciding by a control unit, whether the vehicle is in a creep driving condition;
sensing by the control unit, an opening rate of a brake pedal when the vehicle is in the creep driving condition; and
slipping by the control unit, the plurality of clutches depending on the opening rate of the brake pedal to generate a creep torque.

2. The method of claim 1, wherein the vehicle is determined to be in a creep driving condition in the deciding step when the vehicle runs at a speed less than a reference value, with a change lever in a D range under an OFF state of both a brake pedal and an accelerator pedal.

3. The method of claim 1, wherein of the plurality of clutches, a first clutch is slipped at a first speed to a slip extent according to the opening rate of the brake pedal while a second clutch is slipped at a second speed to a slip extent according to the opening rate of the brake pedal in the generating step.

4. The method of claim 3, wherein the first speed and the second speed are set to be less than a clutch slip speed at which a torsion spring vibrates.
